(19) United States
(12) Patent Application Publication
(10) Pub. No.: US 2014/0188919 A1
(43) Pub. Date: Jul. 3, 2014

(54) DUPLICATE DOCUMENT DETECTION

(71) Applicants: Scott Huffman, Redwood City, CA (US); April Lehman, Mountain View, CA (US); Alexei Stolboushkin, San Carlos, CA (US); Howard Wong-Toi, Albany, CA (US); Fan Yang, Palo Alto, CA (US)

(72) Inventors: Scott Huffman, Redwood City, CA (US); April Lehman, Mountain View, CA (US); Alexei Stolboushkin, San Carlos, CA (US); Howard Wong-Toi, Albany, CA (US); Fan Yang, Palo Alto, CA (US)

(73) Assignee: GOOGLE INC., Mountain View, CA (US)

(21) Appl. No.: 11/675,051

(22) Filed: Feb. 14, 2007

Related U.S. Application Data
(60) Provisional application No. 60/886,868, filed on Jan. 26, 2007.

(51) Int. Cl. G06F 17/30

(52) U.S. Cl. CPC G06F 17/30634
USPC 707/758

(57) ABSTRACT

Methods, program products, and systems for performing a first plurality of computations on non rendered versions of first and second markup language documents to determine a first plurality of signals, each signal in the first plurality of signals representing a comparison of attributes for the non rendered versions of the first and second documents. A second plurality of computations are performed on rendered versions of the first and second markup language documents to determine a second plurality of signals, each signal in the second plurality of signals representing a comparison of attributes for the rendered versions of the first and second documents. The first plurality of signals and the second plurality of signals are combined to determine a confidence as to whether the first and second documents are duplicates.

### CROSS-REFERENCE TO RELATED APPLICATIONS

This application claims priority to pending U.S. Provisional Application Ser. No. 60/886,868, entitled “Duplicate Document Detection”, filed on Jan. 26, 2007, the entire contents of which are hereby incorporated by reference.

### BACKGROUND

Web search engines are useful tools for locating web pages based on search terms. However, a list of search results typically includes two or more web pages that contain the same core content. These are referred to as duplicate documents, even though the appearance of the web pages is not identical, since users looking for the core content would consider one of the documents redundant. For example, web page 102 (FIG. 1) is a rendered version of a markup language document (or document) and web page 202 (FIG. 2) is a rendered version of another document. Both documents contain the same core content 104 despite having differing surrounding content such as navigation bar 106, title 108 and image 206. Content can be duplicated across documents for a number of reasons. Sometimes content is syndicated or the same content is provided in different formats (e.g., optimized for viewing or printing). Duplicate documents clutter search results by pushing relevant results lower in result lists and waste resources by requiring the same content to be crawled and stored more than once by web crawlers.

Traditional techniques for determining whether two documents are duplicates can be confused by the additional content that can surround core content. Additionally, the dynamic nature of web pages make duplicate document detection even harder. In particular, a given document's content can change each time a document is fetched from a web server. For example, Java servlets executing on a web server can dynamically fashion a web page based on Hypertext Transfer Protocol (HTTP) cookies, session variables, or Uniform Resource Locator (URL) rewriting. Moreover, new content can be dynamically incorporated when the document is rendered on a client (e.g., a web browser). Documents that include JavaScript, Hypertext Markup Language (HTML) frames, or Asynchronous JavaScript and XML (AJAX), for example, can cause content to be dynamically incorporated into the rendering based on a user's Internet addresses, the time of year, the time of day, cookies on a user's computer, words contained in the web page, and other information.

For instance, the contents of the advertisement bar 204 on web page 202 is determined by the following JavaScript code in the corresponding document which is executed by a client during rendering of the document:

<script type=“text/javascript”><! -
google_ad_client= “pub-3x92kd940x894501xx2”;
google_ad_width = 728;
google_ad_height = 90;
google_ad_format = “728x90_as”;
google_ad_type = “text_image”;
google_ad_channel = “”;
//--></script>
<script type=“text/javascript”

src=“http://page2.googlesyndication.com/pagead/show_ads.js”?>

</script>

While the above JavaScript code is unchanged each time the document is fetched, the content of the rendered document (i.e., the contents of the add bar 204) can vary each time the document is rendered.

Typical duplicate document detection techniques can become confused by the pathological nature of some web pages. For example, spammers often stuff web pages with invisible keywords which throws off similarity hashing algorithms. Rare terms in HTML boilerplate can lead frequency-inverse document frequency techniques astray. Documents that have little text content create useless snippets for query-based techniques. And some techniques incorrectly ignore small but important details. For example, similar product pages may only differ in a product number yet would be classified as duplicates.

### SUMMARY

In general, one aspect of the subject matter described in this specification can be embodied in a method that includes performing a first plurality of computations on non rendered versions of first and second markup language documents to determine a first plurality of signals, each signal in the first plurality of signals representing a comparison of attributes for the non rendered versions of the first and second documents. A second plurality of computations are performed on rendered versions of the first and second markup language documents to determine a second plurality of signals, each signal in the second plurality of signals representing a comparison of attributes for the rendered versions of the first and second documents. The first plurality of signals and the second plurality of signals are combined to determine a confidence as to whether the first and second documents are duplicates. Other embodiments of this aspect include corresponding systems, apparatus, and computer program products.

These and other embodiments can optionally include one or more of the following features. The first and second plurality of signals are provided as input to a model derived from a machine learning classifier where the model is configured to determine the confidence. The first document and the second document are identified based on a query. Dynamic content is incorporated into the rendered versions of the first and second documents. A signal in the first or the second plurality of signals is a distance-based signal, a simple signal, or a query-based signal.

A distance-based signal can be based on Hamming distance, Levenshtein distance, Damerau-Levenshtein distance, term frequency-inverse document frequency, modified compression normal distance, a longest subsequence, Jaccard distance, or a Charikar random-hyperplane hashing algorithm.

A simple signal can be based on a comparison of titles of the first and second documents, a comparison of the lengths of the rendered or non rendered versions of the first and second documents, a comparison of universal resource locators for the first and second documents, a comparison of compression lengths of the rendered or non rendered versions of the first and second documents, a comparison of fetched strings from the rendered or non rendered versions of the first and second documents, a determination of whether the rendered or non rendered version of the first and second documents is considered spam, or an identification of languages contained in the rendered or non rendered versions of the first and second documents.

A query-based signal can be based on a comparison of snippets from the non rendered or rendered versions of the first and second documents, a frequency of query terms in the non rendered or rendered versions of the first and second documents, a comparison of relevance data for the non rendered or rendered versions of the first and second documents, a comparison of a language of a query to a language of the non rendered or rendered versions of the first and second documents, or a determination of whether the non rendered or rendered versions of the first and second documents include pornography or spam.

The first and second plurality of signals can be: 1) provided as input to a first model derived from a machine learning classifier where the first model is configured to determine the confidence; 2) it is determined if the confidence is below a threshold; 3) a new confidence is determined based on a human comparison of the non rendered or rendered versions of the first and second markup language documents; and 4) the new confidence and the first and second plurality of signals are provided to the machine learning classifier to derive a second model with improved accuracy over the first model.

Particular embodiments of the subject matter described in this specification can be implemented to realize one or more of the following advantages. Duplicate document detection precision (i.e., the fraction of detected true duplicates over all detected duplicates) and recall (i.e., the fraction of detected true duplicates over all duplicates) are improved by comparing rendered versions of documents and by using multiple signals as opposed to one signal for each document. Including query-specific signals can further improve recall. The techniques described herein can be used to avoid crawling mirrored content and infinite hosts, and can be used to maximize unique content in an index. Provides a more accurate evaluation or assessment of result lists returned by search engines.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIGS. 1 and 2 show rendered web pages that contain duplicate content.

FIG. 3 is an illustration of different versions of a document.

FIG. 4 is a flow diagram of a method for detecting duplicate documents.

FIG. 5 is a schematic diagram of a system for detecting duplicate documents.

FIG. 6 is a schematic diagram of a generic computer system.

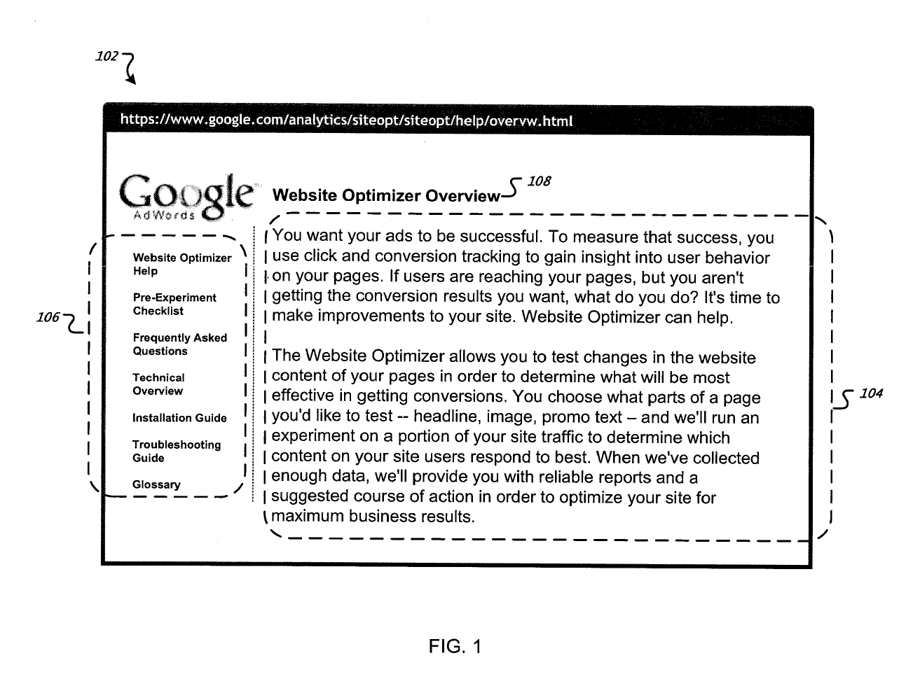

Like reference numbers and designations in the various drawings indicate like elements.

### DETAILED DESCRIPTION

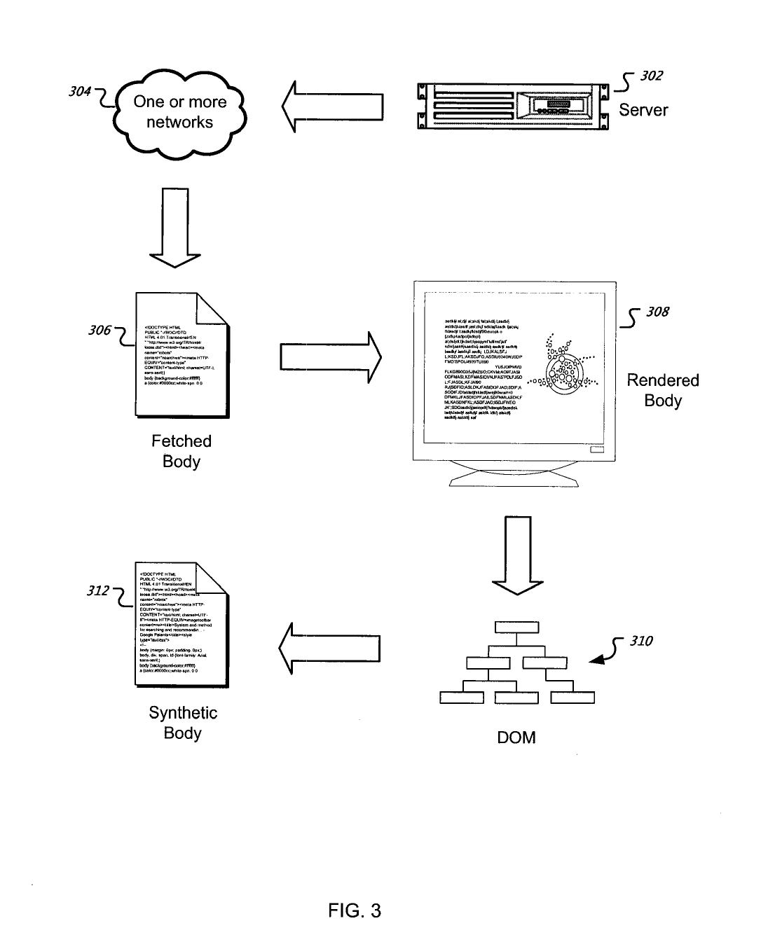

FIG. 3 is an illustration of different versions of a document. A document is a markup language document such as, for example, an HTML or Extensible HTML (XHTML) document. Generally speaking, a document contains a description of how content (e.g. within the document, dynamically determined, and external to the document) is to be presented or formatted in a rendering of the document. By way of illustration, a document 306 referred to as a fetched body can be obtained by a server 302 (e.g., a web server) or other process, or from local or remote storage (e.g., a file system). The source of the document 306 can provide the document 306 through one or more public or private computer networks 304 such as the Internet, for instance. The document 306 can be rendered by a web browser or other process capable of processing the document 306's contents to create a rendered version of the document called a rendered body 308. Doing so could entail incorporating content from HTML frames, executing JavaScript, and so on.

The rendered body 308 is represented as a document object model (DOM) 310 which is a hierarchical representation of the rendered body 308 created during processing of the document 306. The DOM 310 consists of nodes representing HTML elements used to create the rendered body 308. In various implementations, a serialized version of the DOM 310 is referred to as a synthetic body 312. The synthetic body represents the content of the fetched body 306 as well as dynamic content incorporated into the rendered body 308. In some implementations, the synthetic body 312 represents a subset of the content of the rendered body 308.

Duplicate document detection techniques are applied to one or more attributes of a pair of fetched and rendered bodies for a given document pair. Document attributes can include those listed in TABLE 1, however other attributes are possible.

TABLE 1
DOCUMENT BODY ATTRIBUTES

The contents of a body (or selected portions thereof).
The length of a body.
The title of a body.
The Internet domains from whence a fetched body was retrieved.
A query-derived snippet for a body. In various implementations, the snippet is based on
visible text in a body (i.e., text that would appear in the rendered body) rather than being
based on invisible metadata which can be identical for pages on a common website.
Data indicating whether a population of users found a body relevant for a query.
The URL and/or strings derived from the URL of a body.
A collection of words appearing in a body, with or without word frequencies.
A collection of N-word phrases appearing in a body, with or without word frequencies.
The longest substring a body has in common with a body it is being compared to.
A proportion or absolute number of clicks a body receives when presented in search
engine result lists, either for a given query or across all queries.
The number of anchors to the body (i.e., other documents on the Internet which link to
this body).
A list of domains a body's anchors are from, and a frequency of each domain.
The number of outbound links from a body to other documents.
A list of domains a body's outbound links refer to, and a frequency of each domain.
A number of search engine queries issued in a given time period, for which the body was
retrieved as a result.
A list of such search engine queries, with or without frequency of each query.
The distribution of words or phrases in such queries, with or without frequency of each
word/phrase's appearance in queries or in a document collection.
The number of images a rendered body contains.
The number of rendered pixels filled by images versus by text content in a rendered body.

A duplicate document detection technique yields a signal which represents a comparison of attributes associated with a pair of fetched or rendered bodies. By way of illustration, the signal can be a simple Boolean value indicating whether the inputs are considered duplicates of each other, a confidence or probability that the inputs are duplicates, or a set of values. There are different classes of duplicate document detection techniques. TABLE 2 below contains a non-exhaustive list of different classes and exemplary techniques. However, other classes and techniques are possible. In various implementations, a plurality of techniques are applied to a given document pair's fetched and synthetic body attributes in order to determine if the documents are duplicates.

TABLE 1

| DETECTION | |
|---|---|
| CLASS | SIGNAL BASED ON |
| Distance-based | The Hamming distance between strings in a pair of bodies. |
| | The Levenshtein distance between strings in a pair of bodies. |
| | The Damerau-Levenshtein distance between strings in a pair of |
| | bodies. |
| | The term frequency-inverse document frequency (tf-idf) weight of |
| | words in a pair of bodies. The tf-idf distance is a product of the |
| | frequency of a term in a body divided by its frequency in a corpus. In |
| | various implementations, the top 100 tf-idf terms in each body are |
| | compared using a logarithmic idf table. |
| | The longest subsequence in a pair of bodies. |
| | The Jaccard distance between strings in a pair of bodies. |
| | The Charikar random-hyperplane hashing algorithm. |
| | The modified normal compression distance (mcd) between a pair of |
| | bodies based on the compression sizes after concatenating the bodies |
| | together: |
| | $mcd ( A , B ) = \frac{max \{ \vert c ( AB ) - c ( AA ) \vert , \vert c ( AB ) - c ( BB ) \vert \}}{max \{ c ( AA ) , c ( BB ) \}}$ |
| | where A and B are bodies (fetched or synthetic), c is a function that |
| | determines compression distance, AB, AA, BB, and AA represent |
| | different concatenations of the bodies, and max is a function that returns |
| | the largest of its parameters. |
| Simple | Whether the titles of a pair of bodies is the same. |
| | Whether the URL's of a pair of bodies overlap. |
| | A comparison of URLs from which a pair of bodies were fetched, |
| | e.g., same domain (ebay.com), subdomain (autos.ebay.com), or |
| | directory within a domain or subdomain |
| | (autos.ebay.com/chevys/fourdoor). |
| | A comparison of the lengths of a pair of bodies. Let len(X) be the |
| | length of a fetched body for document X. In various |
| | implementations, the body length distance (bld) between bodies A |
| | and B is defined as: |
| | $bld ( A , B ) \{ \begin{matrix}0 if len ( A ) = len ( B ) = 0 \\ \frac{\vert len ( A ) - len ( B ) \vert}{max \{ len ( A ) , len ( B ) \}} otherwise\end{matrix}$ |
| | A comparison of the compression lengths of a pair of bodies. |
| | Whether a pair of fetched body strings are identical. |
| | Human assessor's or automated classifier's judgment of whether a |
| | body is considered “spam”. |
| | Human assessor's or automated classifier's determination of |
| | language(s) contained in a body. |
| Query-based | Comparison of query snippets for a pair of bodies. A snippet is an |
| | extract from a document around words of a query. Many web search |
| | engines include snippets in their search results so that users can |
| | determine if a result is relevant to their query. Snippets are extracted |
| | from a pair of bodies to be compared based on a query associated |
| | with the bodies. For example, the pair of bodies might have both |
| | appeared in the search results for the query from the same or different |
| | search engines. Different detection techniques can be used to |
| | compare the snippets. |
| | The frequency of query terms in a pair of bodies. |
| | Comparison of relevance data for a pair of bodies based on the |
| | number of users that found the bodies relevant for a given query. For |
| | example, the number of times a document was clicked on in a search |
| | result list could serve as a relevance indicator. |
| | Comparison of other aspects of how suitable a pair of bodies are for |
| | the query, e.g., whether the body is in a foreign language compared to |
| | the query, whether the body contains pornography or spam. |
| | Comparison of a human assessors' judgments of relevance of a pair of |
| | bodies with respect to a given query or set of queries. |

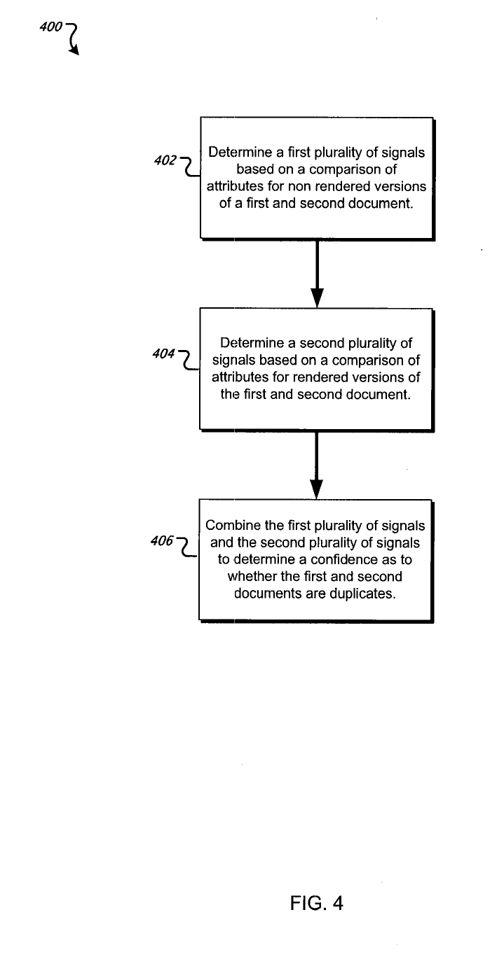

FIG. 4 is a high-level flow diagram of a method 400 for detecting duplicate documents. A first plurality of computations is performed on non rendered versions (e.g., fetched bodies) of first and second markup language documents to determine a first plurality of signals (step 402). Each signal in the first plurality of signals provides a comparison of attributes (see TABLE 1) for the non rendered versions of the first and second documents. A second plurality of computations is performed on rendered versions (e.g., synthetic bodies) of the first and second markup language documents to determine a second plurality of signals (step 404). Each signal in the second plurality of signals provides a comparison of attributes for the rendered versions of the first and second documents. The first plurality of signals and the second plurality of signals are combined using a machine learning-based model to determine a confidence as to whether the first and second documents are duplicates (step 406).

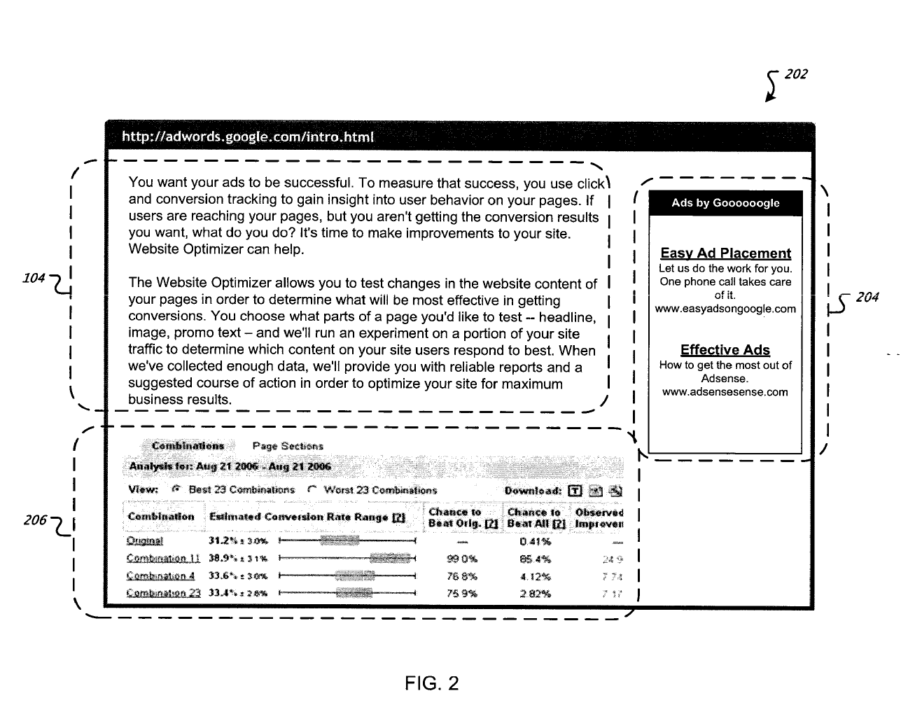

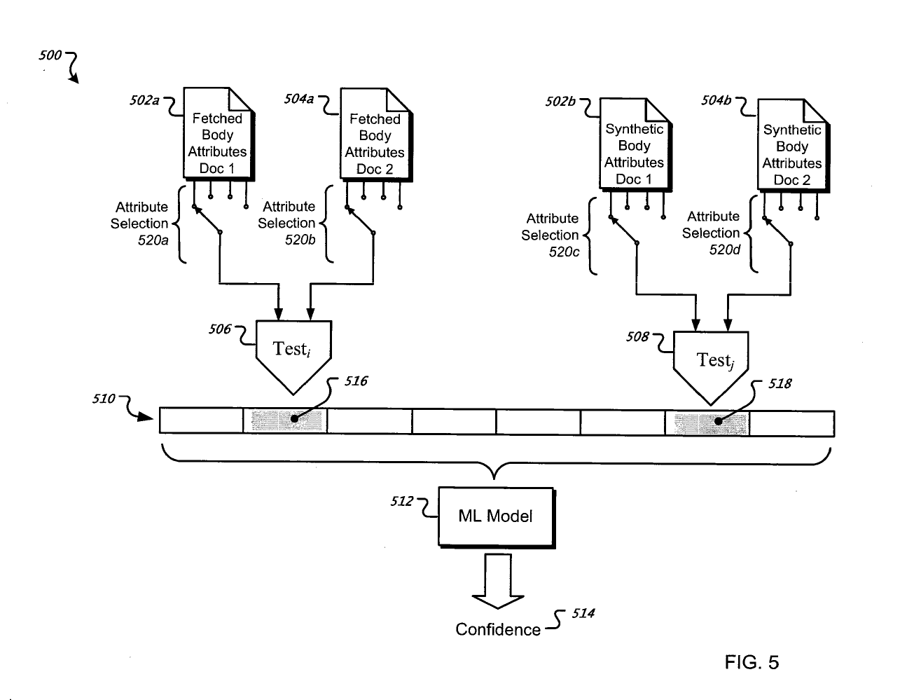

FIG. 5 is a schematic diagram of a system 500 for detecting duplicate documents. A pair of fetched body attributes (502a, 504a) are provided to a series of duplicate document detection tests 506, such as those described in TABLE 2, where each test can potentially compare different attributes from the fetched bodies (502a, 504a) to generate a signal 516. Attributes provided to the tests 506 (see TABLE 1) can be selected by the tests 506 themselves or by another component that provides the selected attributes to the tests 506. Attribute selection 520a-b can be based on rules or heuristics that choose some attributes and ignore others based on the type of test that will be performed. For example, on web page 202 (FIG. 2), advertisement content 204 may not be provided to distance-based tests since such content always changes and does not correspond to what a user would consider core content. Similarly, tests in simple detection classes will be provided only with the attributes those tests are based on (e.g., body titles, body lengths). Moreover, distance-based signals or other signals can be computed after removal of “boilerplate”/non-core content from a body. The signal generated from each test 506 is stored in a separate part of a signal vector 510.

A pair of synthetic body attributes (502b, 504b) corresponding to the fetched body attributes (502a, 504a) are provided to another series of duplicate document detection tests 508 where each test can potentially compare different attributes from the synthetic bodies (502b, 504b) to generate a signal 518. The series of tests 508 can be the same as 506, can be entirely different, or can have some tests in common. As described above, attributes provided to the tests 508 can be selected by the tests 508 themselves or by another component that provides the selected attributes to the tests. The signal generated from each test 508 is stored in a separate part of the signal vector 510.

Once all of the tests 506 and 508 are complete, the signal vector 510 is provided as input to a model 512 that determines a confidence 514 as to whether the pair of documents corresponding to the bodies 502a-b and 504a-b are duplicates. The model 512 is derived from a machine learning algorithm (MLA) that has been trained with a data set comprising tuples consisting of a signal vector (derived as described above) for a pair of documents and an indication of whether the documents are duplicates. The MLA builds the classification model 512 based on the training data set. In various implementations, the model 512 is generated by a MLA such as a propositional rule learner (e.g., JRIP) or a decision tree classifier (e.g., J48) available in the Waikato Environment for Knowledge Analysis (Weka). Weka is a collection of MLAs for data mining that can be applied directly to data sets or invoked programmatically. Weka is available from the University of Waikato in New Zealand. In further implementations, the model can be produced by other tree-based classifiers, rule-based classifiers (e.g., RIPPER), neural network-based classifiers, Bayesian network classifiers, decision-tree classifiers (e.g., ID3 and C4.5), logistic or linear regression-based classifiers, nearest neighbor/instance-based classifiers, or combinations of these.

In other implementations, a small set of simple screening tests can be performed on a pair of fetched and/or rendered bodies to determine whether further testing is warranted. If not, the full suite of tests as described above will not be performed on the pair.

In additional implementations, the model produces a confidence as to whether the pair of documents are duplicates. If the confidence is above some threshold, the classifier's classification is accepted. If the confidence is below some threshold, one or more human assessors are shown the pair of documents and asked to make a confidence judgment. Optionally, these additional human assessed pairs may be added to the training data set to generate a model with improved classification accuracy.

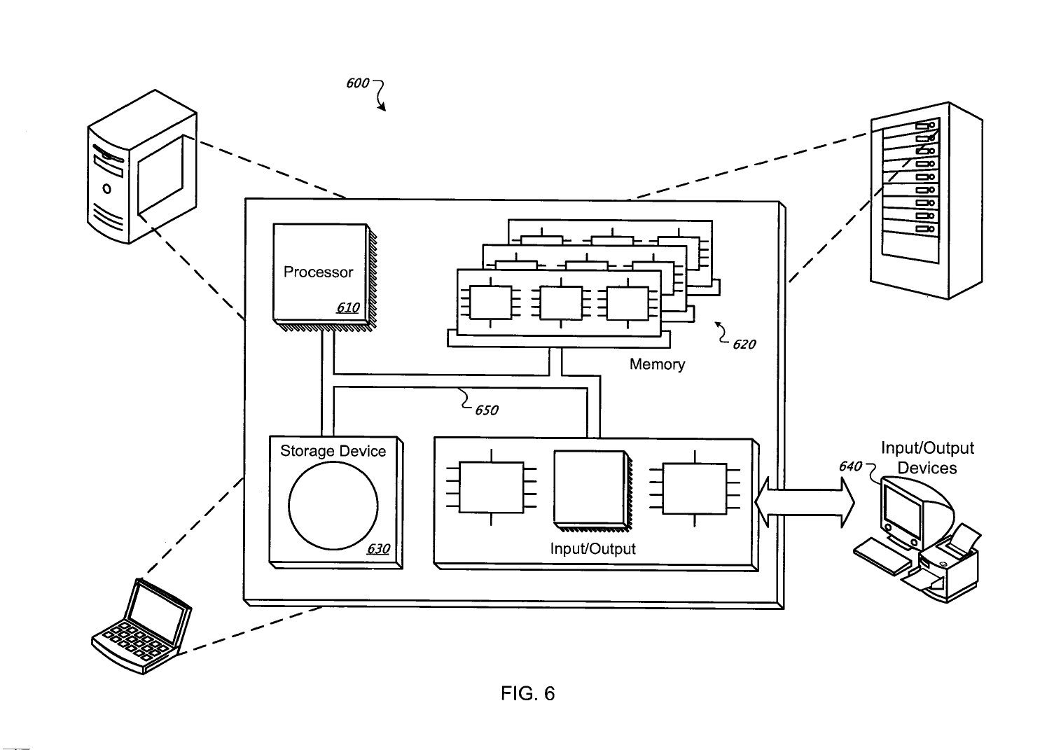

FIG. 6 is a schematic diagram of a generic computer system 600. The system 600 can be used for practicing operations described in association with the method 400 and system 500. The system 600 can include a processor 610, a memory 620, a storage device 630, and input/output devices 640. Each of the components 610, 620, 630, and 640 are interconnected using a system bus 650. The processor 610 is capable of processing instructions for execution within the system 600. Such executed instructions can implement one or more steps of method 400, for example. In one implementation, the processor 610 is a single or multi-threaded processor, or a collection of processors. The processor 610 is capable of processing instructions stored in the memory 620 or on the storage device 630 to perform duplicate document detection.

The memory 620 is a computer readable medium such as volatile or non volatile random access memory that stores information within the system 600. The memory 620 could store data structures representing fetched and synthetic document bodies, signal vectors, and a model, for example. The storage device 630 is capable of providing persistent storage for the system 600. The storage device 630 may be a floppy disk device, a hard disk device, an optical disk device, or a tape device, or other suitable persistent storage means. The input/output device 640 provides input/output operations for the system 600. In one implementation, the input/output device 640 includes a keyboard and/or pointing device. In another implementation, the input/output device 640 includes a display unit for displaying graphical user interfaces. The input/output device 640 can provide input/output operations for the system 600.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

What is claimed is:

1. A computer-implemented method, comprising:
performing a first plurality of tests on non rendered versions of a first and a second markup language document to determine a first plurality of signals, each signal in the first plurality of signals representing a comparison of particular document body attributes for the non rendered versions of the first and second documents, wherein a signal of the plurality of signals is a query-based signal that is based on a comparison of a respective snippet of the first and second documents;
performing a second plurality of tests on rendered versions of the first and second markup language documents to determine a second plurality of signals, each signal in the second plurality of signals representing a comparison of particular synthetic body attributes, corresponding to the particular document body attributes, for the rendered versions of the first and second documents, wherein a signal of the plurality of signals is a query-based signal that is based on a comparison of a respective snippet of the first and second documents;
generating a signal vector that includes each of the first plurality of signals and each of the second plurality of signals; and
providing the signal vector as an input to a machine learning classifier model that has been trained on the first and second plurality of signals to determine a confidence as to whether the first and second documents are duplicates.

2. (canceled)

3. The method of claim 1 wherein each signal in the first plurality of signals is a distance-based signal, a simple signal, or a query-based signal, and wherein each signal in the second plurality of signals is a distance-based signal, a simple signal, or a query-based signal.

4. The method of claim 3 wherein the distance-based signal is based on Hamming distance, Levenshtein distance, Damerau-Levenshtein distance, term frequency-inverse document frequency, modified compression normal distance, a longest subsequence, Jaccard distance, or a Charikar random-hyperplane hashing algorithm.

5. The method of claim 3 wherein the simple signal is based on a comparison of titles of the first and second documents, a comparison of the lengths of the rendered or non rendered versions of the first and second documents, a comparison of universal resource locators for the first and second documents, a comparison of compression lengths of the rendered or non rendered versions of the first and second documents, a comparison of fetched strings from the rendered or non rendered versions of the first and second documents, a determination of whether the rendered or non rendered version of the first and second documents is considered spam, or an identification of languages contained in the rendered or non rendered versions of the first and second documents.

6. The method of claim 3 wherein the query-based signal is further based on a frequency of query terms in the non rendered or rendered versions of the first and second documents, a comparison of relevance data for the rendered versions of the first and second documents, a comparison of a language of a query to a language of the non rendered or rendered versions of the first and second documents, or a determination of whether the non rendered or rendered versions of the first and second documents include pornography or spam.

7. The method of claim 1, further comprising identifying the first document and the second document based on a search engine query.

8. The method of claim 1, further comprising incorporating dynamic content into the rendered versions of the first and second documents.

9. The method of claim 1, further comprising:
providing the first and second plurality of signals as input to a first model derived from a machine learning classifier where the first model is configured to determine the confidence;
determining if the confidence is below a threshold;
obtaining a new confidence based on a human comparison of the non rendered or rendered versions of the first and second markup language documents; and
providing the new confidence and the first and second plurality of signals to the machine learning classifier to derive a second model with improved accuracy over the first model.

10. A non-transitory computer program product, stored on a computer-readable medium which, when executed by data processing apparatus, is operable to cause the data processing apparatus to perform operations comprising:
performing a first plurality of tests on non rendered versions of a first and a second markup language document to determine a first plurality of signals, each signal in the first plurality of signals representing a comparison of particular document body attributes for the non rendered versions of the first and second documents, wherein a signal of the plurality of signals is a query-based signal that is based on a comparison of a respective snippet of the first and second documents;
performing a second plurality of tests on rendered versions of the first and second markup language documents to determine a second plurality of signals, each signal in the second plurality of signals representing a comparison of particular synthetic body attributes, corresponding to the particular document body attributes, for the rendered versions of the first and second documents, wherein a signal of the plurality of signals is a query-based signal based on a comparison of a respective snippet of the first and second documents;
generating a signal vector that includes each of the first plurality of signals and each of the second plurality of signals; and
providing the signal vector as an input to a machine learning classifier model that has been trained on the first and second plurality of signals to determine a confidence as to whether the first and second documents are duplicates.

11. (canceled)

12. The program product of claim 10 wherein each signal in the first plurality of signals is a distance-based signal, a simple signal, or a query-based signal, and wherein each signal in the second plurality of signals is a distance-based signal, a simple signal, or a query-based signal.

13. The program product of claim 12 wherein the distance-based signal is based on Hamming distance, Levenshtein distance, Damerau-Levenshtein distance, term frequency-inverse document frequency, modified compression normal distance, a longest subsequence, Jaccard distance, or a Charikar random-hyperplane hashing algorithm.

14. The program product of claim 12 wherein the simple signal is based on a comparison of titles of the first and second documents, a comparison of the lengths of the rendered or non rendered versions of the first and second documents, a comparison of universal resource locators for the first and second documents, a comparison of compression lengths of the rendered or non rendered versions of the first and second documents, a comparison of fetched strings from the rendered or non rendered versions of the first and second documents, a determination of whether the rendered or non rendered version of the first and second documents is considered spam, or an identification of languages contained in the rendered or non rendered versions of the first and second documents.

15. The program product of claim 12 wherein the query-based signal is further based on a frequency of query terms in the non rendered or rendered versions of the first and second documents, a comparison of relevance data for the rendered versions of the first and second documents, a comparison of a language of a query to a language of the non rendered or rendered versions of the first and second documents, or a determination of whether the non rendered or rendered versions of the first and second documents include pornography or spam.

16. The program product of claim 10, wherein the operations further comprise identifying the first document and the second document based on a search engine query.

17. The program product of claim 10, wherein the operations further comprise incorporating dynamic content into the rendered versions of the first and second documents.

18. The program product of claim 10, further comprising:
providing the first and second plurality of signals as input to a first model derived from a machine learning classifier where the first model is configured to determine the confidence;
determining if the confidence is below a threshold;
obtaining a new confidence based on a human comparison of the non rendered or rendered versions of the first and second markup language documents; and
providing the new confidence and the first and second plurality of signals to the machine learning classifier to derive a second model with improved accuracy over the first model.

19. A system comprising:
data processing apparatus programed to perform operations comprising:
performing a first plurality of tests on non rendered versions of a first and a second markup language document to determine a first plurality of signals, each signal in the first plurality of signals representing a comparison of particular document body attributes for the non rendered versions of the first and second documents, wherein a signal of the plurality of signals is a query-based signal that is based on a comparison of a respective snippet of the first and second documents;
performing a second plurality of tests on rendered versions of the first and second markup language documents to determine a second plurality of signals, each signal in the second plurality of signals representing a comparison of particular synthetic body attributes, corresponding to the particular document body attributes, for the rendered versions of the first and second documents, wherein a signal of the plurality of signals is a query-based signal based on a comparison of a respective snippet of the first and second documents;
generating a signal vector that includes each of the first plurality of signals and each of the second plurality of signals; and
providing the signal vector as an input to a machine learning classifier model that has been trained on the first and second plurality of signals to determine a confidence as to whether the first and second documents are duplicates.

20. (canceled)

21. The system of claim 19 wherein each signal in the first plurality of signals is a distance-based signal, a simple signal, or a query-based signal, and wherein each signal in the second plurality of signals is a distance-based signal, a simple signal, or a query-based signal.

22. The system of claim 21 wherein the distance-based signal is based on Hamming distance, Levenshtein distance, Damerau-Levenshtein distance, term frequency-inverse document frequency, modified compression normal distance, a longest subsequence, Jaccard distance, or a Charikar random-hyperplane hashing algorithm.

23. The system of claim 21 wherein the simple signal is based on a comparison of titles of the first and second documents, a comparison of the lengths of the rendered or non rendered versions of the first and second documents, a comparison of universal resource locators for the first and second documents, a comparison of compression lengths of the rendered or non rendered versions of the first and second documents, a comparison of fetched strings from the rendered or non rendered versions of the first and second documents, a determination of whether the rendered or non rendered version of the first and second documents is considered spam, or an identification of languages contained in the rendered or non rendered versions of the first and second documents.

24. The system of claim 21 wherein the query-based signal is further based on a frequency of query terms in the non rendered or rendered versions of the first and second documents, a comparison of relevance data for the rendered versions of the first and second documents, a comparison of a language of a query to a language of the non rendered or rendered versions of the first and second documents, or a determination of whether the non rendered or rendered versions of the first and second documents include pornography or spam.

25. The system of claim 19, wherein the operations further comprise identifying the first document and the second document based on a search engine query.

26. The system of claim 19, wherein the operations further comprise incorporating dynamic content into the rendered versions of the first and second documents.

27. The system of claim 19, wherein the operations further comprise:
providing the first and second plurality of signals as input to a first model derived from a machine learning classifier where the first model is configured to determine the confidence;
determining if the confidence is below a threshold;
obtaining a new confidence based on a human comparison of the non rendered or rendered versions of the first and second markup language documents; and
providing the new confidence and the first and second plurality of signals to the machine learning classifier to derive a second model with improved accuracy over the first model.
